(19) United States
(12) Patent Application Publication
(10) Pub. No.: US 2011/0105079 A1
(43) Pub. Date: May 5, 2011

(54) Liberty phone and liberty phone system

(76) Inventor: Mark Randall Levea, Paris, VA (US)

(21) Appl. No.: 12/291,150

(22) Filed: Nov. 7, 2008

Related U.S. Application Data
(60) Provisional application No. 61/002,948, filed on Nov. 14, 2007.

(51) Int. Cl. H04W 88/02; H04W 12/06

(52) U.S. Cl. 455/411; 455/575.1; 455/556.1; 455/572

(57) ABSTRACT

The Liberty Phone and Phone System is an improved and hardened cellular phone design and system that cannot be used as an initiator device for an Improvised Explosive Device (IED). The basic design of the Liberty Phone makes it economically infeasible for it to be used as an initiator for IEDs. No external data connections are provided and the design makes it impossible to disassemble without disabling it. Any attempt to use the information from a disabled unit by an unauthorized individual would require the aid of a microelectronics lab and a micro-machine shop. The Liberty Phone design effectively removes the cellular phone as an instrument of remote IED initiations.

### PRIORITY

Priority is claimed to Provisional Application No. 61/002,948 filed on Nov. 14, 2007.

### FIELD OF INVENTION

This invention relates to improved and hardened cellular phone designs that can not be used as an initiator device for an Improvised Explosive Device (IED).

### BACKGROUND OF THE INVENTION

In the recent past, especially in Afghanistan and Iraq, US military personnel have been attacked by Improvised Explosive Devices (IEDs). Most of these devices have been initiated by remote control by using cell phone technology. It had become evident that somehow blocking or disabling the use of this type of technology would overcome this particular threat. The instant invention, the Liberty Phone and Phone System, addresses this threat and challenge by making it economically infeasible for this particular cell phone and system to be used as an initiator for IEDs. No external data connections are provided and the design makes it impossible to disassemble without disabling it. Any attempt to use the information from a disabled unit by an unauthorized individual would require the aid of a microelectronics lab and a micro-machine shop. The Liberty Phone design effectively removes the cellular phone as an instrument of remote IED initiations. This phone and system can thereby replace any and all existing systems within an area or region so as to reduce or remove the threat of Improvised Explosive Devices (IEDs) within that area or region.

### SUMMARY OF THE INVENTION

The instant invention relates to improved and hardened cellular phone designs that can not be used as an initiator device for an Improvised Explosive Device (IED). The Liberty Phone infrastructure specifies SIGINT fusion to provide GPS tracking, individual conversation monitoring, conversation scanning for keywords or phrases, eavesdropping, digital encrypted transmissions capture and auto-interrupt and remote shutdown with data fusion from UAV infra-red and visual to provide a substantial overall picture of the populace, it's movements, communications and even identify the actions of non-users. In the liberated territory an individual's cell phone can now be used as Personal Identification Device and infractions put in place for possessing another's Cell Phone/PID. Distribution can be in phases and sold at cost to those with the money before subsidized Liberty Phones are given away to everyone.

SIGINT is defined by the Wikipedia internet encyclopedia as Signals intelligence (often contracted to SIGINT) is intelligence-gathering by interception of signals, whether between people (i.e., COMINT or communications intelligence) or between machines (i.e., ELINT or electronic intelligence), or mixtures of the two. As sensitive information is often encrypted, signals intelligence often involves the use of cryp Signals intelligence (often contracted to SIGINT) is intelligence-gathering by interception of signals, whether between people (i.e., COMINT or communications intelligence) or between machines (i.e., ELINT or electronic intelligence), or mixtures of the two. As sensitive information is often encrypted, signals intelligence often involves the use of cryptanalysis. However, traffic analysis—the study of who is signalling whom and in what quantity—can often produce valuable information, even when the messages themselves cannot be decrypted. tanalysis. However, traffic analysis—the study of who is signalling whom and in what quantity—can often produce valuable information, even when the messages themselves cannot be decrypted.

The instant invention also incorporates the use of WiMAX technology. WiMAX (definition published with the Wikipedia internet encyclopedia) is a contraction of the phrase “Worldwide Interoperability for Microwave Access”, which is a telecommunications technology that provides for the wireless transmission of data in a variety of ways, ranging from point-to-point links to full mobile cellular-type access. The technology provides broadband speed without the need for cables. The technology is based on the IEEE 802.16 standard (also called WirelessMAN). The name “WiMAX” was created by the WiMAX Forum, which was formed in June 2001 to promote conformity and interoperability of the standard. The forum describes WiMAX as “a standards-based technology enabling the delivery of last mile wireless broadband access as an alternative to cable and DSL” (and also to High Speed Packet Access).

The instant invention further incorporates an LCD, which is (definition published with the Wikipedia internet encyclopedia) a liquid crystal display (LCD) is an electro-optical amplitude modulator realized as a thin, flat display device made up of any number of color or monochrome pixels arrayed in front of a light source or reflector. It is often utilized in battery-powered electronic devices because it uses very small amounts of electric power.

The instant invention further incorporates a “light gate”, which is a term used in camera building technology and defined herein as an access port and/or connection that has numerous physical angular shapes formed therein such that a ray of light cannot penetrate therethrough. This is used to make sure that an individual cannot simply stick a pin therein and make a connection to the electrical circuit. Like a ray of light that would have to bend around corners to get through a light gate, a pin would have to bend around corners to be able to make an electrical connection.

### BRIEF DESCRIPTION OF THE DRAWINGS

FIG. 1 is a front view of the Liberty Phone

FIG. 2 is a side view of the Liberty Phone

FIG. 3 is a back view of the Liberty Phone

FIG. 4 is a side view of the electronics and hardware of the Liberty Phone before being placed and secured with epoxy within the armored case

FIG. 5 is a cross sectional side view of the armored case

### DESCRIPTION OF THE PREFERRED EMBODIMENT

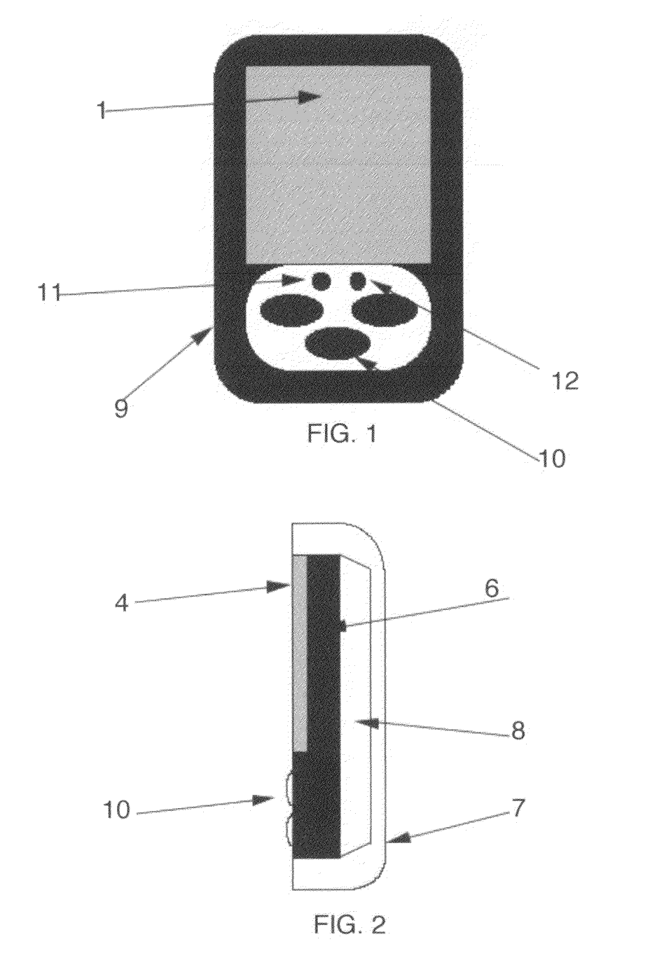

The preferred embodiment of the Liberty Phone and Phone System, best shown as member 1 in FIG. 1, includes the following:

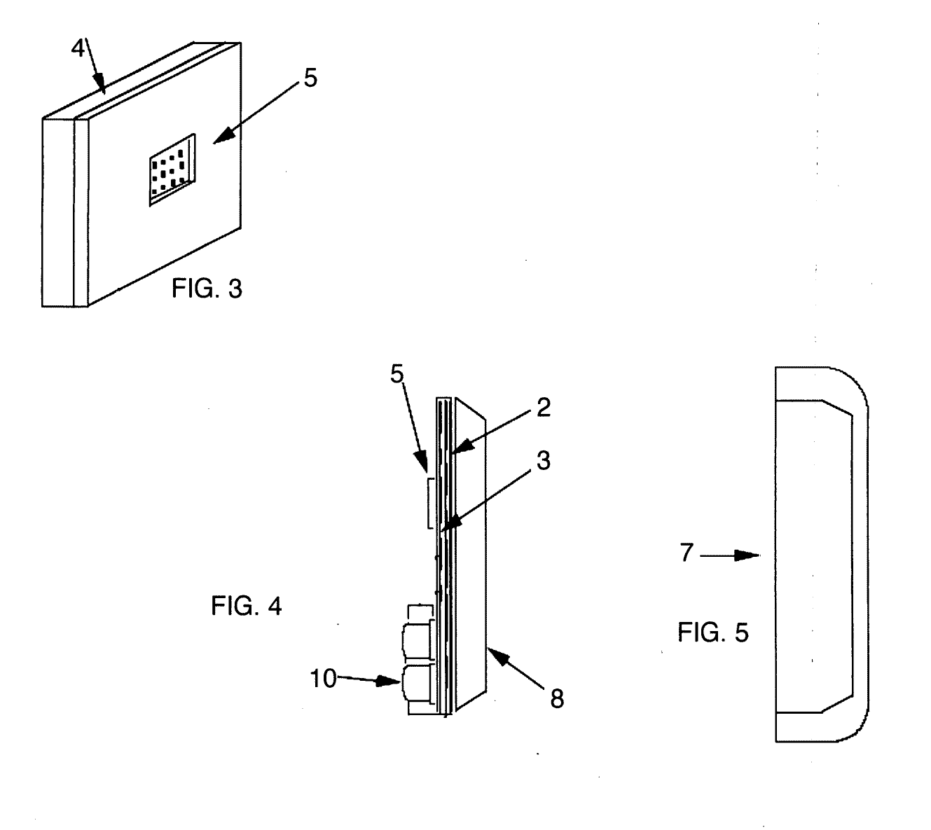

First miniaturize a WiMAX phone's circuitry, shown as members 2 and 3 in FIG. 4, and eliminate any external connections for communications, such as a BLUETOOTH or plug-in connector. Assure that no voltage drop can be seen across the battery charging circuit by supplying a voltage control module to govern the circuit. Then “fold over” and “sandwich” the entire circuitry to make access very difficult, again as shown as members 2 and 3 in FIG. 4. Connect an LCD, member 4, to the circuitry via a “light gate” type of connection, shown as member 5 in FIG. 3, to make access nearly impossible. Finally, using an epoxy material, member 6, fill and embed the assembly into an armored case, shown in FIG. 5 as member 7. The phone further includes an armored battery, member 8; a battery charger connection with voltage control circuitry, member 9; function buttons, members 10; a speaker, as member 11; and a microphone, as member 12. Recent technology advancements now have entire cell phone systems on a single chip (system on chip SoC). While this is quite desirable from a micro-electronics standpoint the fact still exists that the single chip would also have to be armored to resist penetration instead of the multi-chip folding technique mentioned above.

The assumption is that miniaturized circuitry using micro-electronics technology to produce a phone with either a folded and sandwiched circuit design, a single SoC, or a micro-electronics phone with a folded and sandwiched and sealed armored design will not be able to be successfully breached and utilized as an initiator without the help of a multi billion dollar microelectronics and machining lab. This effectively places the price to use the phone as an initiator so far upscale it is not practical anymore. Liberty Phone can be remotely de-activated. A simple system consisting of an additional command in the phone's command set and the ability to issue the command from the management infrastructure can be made to automatically de-activate a civilian Liberty Phone when US or coalition forces are within a certain proximity. The Liberty Phone is the only totally non-COTS (commercial-off-the-shelf) product, which thereby substantially reduces the time it takes to get from design to having it working in the field.

The epoxy used within this configuration should have a high thermal conductivity or else a heat sinking mechanism should be incorporated in order to conduct the heat produced by the microelectronics chip to the outside casing.

Phones as ID Devices—When you register and purchase a Liberty Phone your facial image is captured and can be stored in a data base. Subsequent ID checks can refer to the image to assure phones are not being traded and surveillance confidence is greater.

### Liberty Phone Infrastructure:

The design is based on standard 802.16 WiMax for quick implementation into the field.

The supplier of the WiMax infrastructure will be asked to generate a special military version Operating System or hardware that will include one or more of the following options:

Known ID Access Only—Only valid Liberty Phones will be allowed to be used in the liberated territory.

Non Commercial Frequency—A different frequency can be used can be used to provide a higher level of isolation for the phone network.

Military Encryption Protocol—This may be excessive for civilian use but a full featured Liberty Phone can easily be manufactured for US personnel use.

SIGINT—Existing intelligence gathering applications can easily be integrated into the Liberty Phone Infrastructure. Digitally capturing conversations for keyword or phrase analysis plus eavesdropping and GPS tracking are all built in to the Liberty Phone design.

Data Fusion—Since we have a tracking device on almost everyone in the populace and we know when each device stops moving, it would be possible to set an alarm level within the management infrastructure when there is no movement and coincide the GPS location with UAV infrared or visual video capture. Ascertain the situation, deactivate the phone and send personnel in to investigate. If 50 terrorists leave their phones at home and travel to their meeting, we can be there too. Also non-moving, non-human accompanied Liberty Phones that have no co-located infra-red are located in suspicious areas such as market places or cross roads they can also be deactivated.

### Liberty Phone US Personnel Only:

A full featured Liberty Phone can be supplied to US personnel. The full featured phone can have a Bluetooth interface. Since WiMax supports voice and video each Military Liberty Phone can also incorporate video teleconferencing which could be invaluable in the war theater. A Military Liberty Phone could be used by authorities to check the ID and picture of every Liberty Phone user stopped on the street. It is expected a full featured Military Liberty Phone would be about the size of a large wrist watch.

### Selective Use Near Military Personnel Carrying Liberty Phones:

A system can be set up to track a set of soldier's Liberty Phone IDs. Through GPS fusion you could find civilian Liberty Phones in a given proximity and deny them service.

Through UAV data fusion you could identify and deactivate any Liberty Phone which does not have a corresponding heat signature and showed no movement.

### Distribution and Use:

Ideally we are replacing an infrastructure that suffered heavy damage during a campaign to liberate a territory. The Liberty Phone System's greatest asset is that no other phones are allowed to work within the liberated territory. Thus there will be no more cellular initiated IEDs.

Distribution—The recommended distribution procedure will be in phases.

Phase one—any citizen may buy a new Liberty Phone at government cost plus handling.

Phase two—increasing government subsidies to get the phones in the hands of those less fortunate.

Phase three—Free phones to those unable to buy phones at cost or with subsidies.

Airport Distribution—Since no other civilian mobile phones are allowed to work in the liberated territory other distribution/registration points will need to be provided to provide travelers with temporary phones or souveniers.

Object—To get as many devices into the hands of the local populace for as much surveillance as possible.

### Prototype, Integrate, Manufacture:

The team should be constructed from individuals who have distinguished themselves the following areas.

Human Interface Design—Touch-screen interface with minimal function buttons.

Electronic Miniaturization—Micro-miniature design team possibly using SoC.

Packaging—A thin armor is needed for the unit to protect its circuitry.

Special Circuitry—No voltage drop may be seen across the battery charging port since that could signal an IED. A shift from the commercial frequency would isolate the phone system from other WiMax phones.

Infrastructure—If a frequency shift is used a corresponding change in the infrastructure is necessary.

SIGINT—Phone taps, eavesdropping, keyword and phrase processing, GPS tracking and fusion from other data sources like UAV infra-red and visual video.

### Additional Functionality:

Situational awareness can be enhanced significantly by also allowing visual and infra-red real time video broadcast from UAV to be viewed by some or all the participants

Any and all other obvious modifications to one or more of the parts of this invention are inherently incorporated herein.

What is claimed is:

1. A cellular phone comprising electronic circuitry; an electronic circuit board upon which said electronic circuitry is attached and connected, wherein the electronic circuit board is folded over upon itself thereby surrounding and enclosing said electronic circuitry between folded portions of the circuit board and thereby making manual access very difficult; an armored casing enclosing and protecting the electronic circuitry and the electronic circuit board; and a hardened material filling the entire empty space within the casing, surrounding the said electronic circuitry and said electronic circuit board, and thereby solidifying the entire phone as one solid unit.

2. The cellular phone of claim 1, wherein the electronic circuitry includes WiMAX technology.

3. The cellular phone of claim 2, wherein the electronic circuitry further includes SIGINT technology.

4. The cellular phone of claim 1, wherein the hardened material is chosen from a group of materials that includes epoxy compounds.

5. The cellular phone of claim 1, further comprising an identification device, such that a user can register the phone using a facial image that is captured by the identification device and stored in a data base.

6. The cellular phone of claim 1, further comprising an armored battery; and a battery charger connection with voltage control circuitry.

7. A set of cell phones adapted to form a system that is highly resistant against tampering or misuse, the system comprising a plurality of cell phones, each cell phone comprising electronic circuitry; an electronic circuit board upon which a said electronic circuitry is attached and connected, wherein the electronic circuit board is folded over upon itself thereby surrounding and enclosing said electronic circuitry between folded portions of the circuit board and thereby making manual access very difficult; an armored casing enclosing and protecting the electronic circuitry and the electronic circuit board; and a hardened material filling the entire empty space within the casing, surrounding the said electronic circuitry and said electronic circuit board, and thereby solidifying the entire phone as one solid unit.

8. The set of cell phones of claim 7, wherein the electronic circuitry includes WiMAX technology.

9. The set of cell phones of claim 8, wherein the electronic circuitry further includes SIGINT technology.

10. The set of cell phones of claim 7, wherein the hardened material is chosen from a group of materials that includes epoxy compounds,

11. The set of cell phones of claim 7, further comprising an identification device, such that a user can register the phone using a facial image that is captured by the identification device and stored in a data base.

12. The set of cell phones of claim 7, further comprising an armored battery; and a battery charger connection with voltage control circuitry.

13. A method of denying the initiation of improvised explosive devices (IEDs) by the use of cell phone technology within a given territory comprising the steps of denying functionality of all other cell phone devices within said territory; providing cell phones, as set forth in claim 1, to all individuals that were denied functionality of their previous cell phones; and distributing cell phones, as set forth in claim 1, to all individuals that require cell phone use in said territory.

14. The method of claim 13 wherein the electronic circuitry includes WiMAX technology.

15. The method of claim 14 wherein the electronic circuitry further includes SIGINT technology.

16. The method of claim 13 wherein the hardened material is chosen from a group of materials that includes epoxy compounds,

17. The method of claim 13 further comprising an identification device, such that a user can register the phone using a facial image that is captured by the identification device and stored in a data base.

18. The set of cell phones of claim 13 further comprising an armored battery; and a battery charger connection with voltage control circuitry.
